(19) United States
(12) Patent Application Publication
(10) Pub. No.: US 2016/0302894 A1
(43) Pub. Date: Oct. 20, 2016

(54) ASSEMBLY AND METHOD FOR MANUFACTURING DENTAL PROSTHESES

(71) Applicants: Fabio Emilio GANDOSSI, San Paolo d'Argon (IT); BREDA STEFANO, Albino (Bergamo) (IT)

(72) Inventors: STEFANO BREDA, ALBINO (BERGAMO) (IT); FABIO EMILIO GANDOSSI, SAN PAOLO d'ARGON (IT)

(21) Appl. No.: 15/103,223

(22) PCT Filed: Dec. 22, 2014
(86) PCT No.: PCT/EP2014/003459

§ 371 Date: Jun. 9, 2016

(30) Foreign Application Priority Data
Dec. 23, 2013 (IT) MI2013A002191

(51) Int. Cl. A61C 13/00; B29C 41/20; B29C 65/48; A61C 8/00; A61C 13/20

(52) U.S. Cl. CPC A61C 13/0003; A61C 13/0028; A61C 8/0027; A61C 8/0048; A61C 13/20; A61C 13/0027; B29C 65/48; B29C 41/20; A61C 2013/2753

(57) ABSTRACT

An assembly for manufacturing dental prostheses includes a set of modular members constituted by a straight bar, a curved bar, a plurality of cylinders and two end members, adapted to be assembled and soldered to each other to form a reinforcement frame of a dental prosthesis, under immediate load and executable within the same day. The method for manufacturing dental prostheses includes assembling the components and mutually soldering them so as to form a rigid reinforcement frame of a dental prostheses that can be applied to the implants inserted previously in the lower or upper arch of the patient.

The present invention relates to an assembly and to a method for manufacturing dental prostheses.

The present invention relates in particular to an assembly and to a method for manufacturing prostheses of the so-called “Toronto bridge” type.

As is known, the Toronto bridge is a fixed prosthesis that is applied by screwing it onto the implants.

The Toronto bridge prosthesis is characterized in that the number of restored teeth does not correspond to the number of implants, a minimum of four, in the upper arch or in the lower arch, onto which a prosthesis is screwed which ensures that the patient has a stability and comfort that is similar to those of his own teeth.

A Toronto bridge is normally manufactured in the following manner.

After performing a CT, a template is built, by means of adapted software, that guides the operator in inserting the implants.

The implants can be positioned transmucosally, i.e., without cutting the gums, or directly after the extraction of a broken or parodontopathic dental member, in which the implant is positioned directly in the dental alveolus.

By using temporary pillars screwed to the implants that have just been placed, the patient is provided with a temporary prosthesis, prepared beforehand in a laboratory, which is intended not only to recover the aesthetics and the masticatory function but also for the healing of the underlying tissues.

After approximately 4-6 months, one moves on to the final step, i.e., the construction of the final Toronto bridge prosthesis. This prosthesis is made after taking a precision impression: a supporting structure made of metal or titanium and zirconium or fibers is built, and the final teeth, made of resin or composite or ceramics, as chosen by the patient, are modeled on this structure.

The prosthesis remains fixed to the implants and therefore is not removed; it is possible to achieve a high aesthetic level, mastication occurs as with natural teeth, hygiene is performed with maximum ease and, very importantly, the dentist can remove it in case of problems affecting the implants or to carry out professional hygiene.

According to the traditional method of application of the prosthesis, the time required to complete the work varies from 4 to 8 months for the finished work. Various methods are also known that allow an immediate loading of a Toronto bridge, with variables such as delivery time, costs, and the possibility to ensure absolute passivation.

Methods with modeling and casting of the prosthesis with delivery times from 24 to 72 hours are known. Those methods entail the provision of a metallic frame, assembled on a mold, and the subsequent forming, by casting or milling, of the actual prosthesis.

Methods are also known which do not entail a metal frame; however, prostheses without a metal frame have a higher risk of breaking than prostheses reinforced with a metal frame.

Other computerized methods, introduced recently on the market, entail dedicated templates for the insertion of the implants, with corresponding high costs, and do not allow delivery in short times of the final prosthetic article.

U.S. Pat. No. 5,419,700 discloses a support structure for a removable prosthesis constituted by a bar that is screwed to the implants and by a complementary bar, the bars being mutually joined by means of some and different anchoring systems. The structure disclosed by U.S. Pat. No. 5,419,700 provides for the construction of a bar with a stress breaker, that is subsequently joined by soldering, and a second structure that accommodates the retention systems and the dental members. The structure disclosed in U.S. Pat. No. 5,419,700 does not allow to provide and complete prosthesis in a one-day session and requires integration of the implants. Therefore, a few months after the operation must pass in order to provide a definitive prosthesis for the patient.

U.S. Pat. No. 5,674,070 discloses a method for manufacturing of a removable prosthesis, having bars that are anchored to implants, and a kit constituted by the anchoring systems. The system described in U.S. Pat. No. 5,674,070 requires integration of the implants in the bone to have occurred, and therefore a few months must pass after the operation before it is possible to provide the patient with a prosthesis.

Both the above cited prior art structures require a supporting workshop capable of casting the structures or a workshop capable of milling the structures.

The aim of the present invention is to provide a structure and a method for providing dental prostheses that overcome the drawbacks of the cited prior art.

Within the scope of this aim, an object of the invention is to provide a structure and a method that constitute a simple, repeatable and most of all effective technique that allows to restore a partially or totally edentulous mouth within a few hours after the insertion of the implants, with a dental prosthesis, of the Toronto bridge type, screwed onto implants and perfectly passive.

A further object of the invention is to provide a system that allows to manufacture a complete prosthesis within a dentist's surgery without having to necessarily rely on an external dentistry laboratory.

Within this scope, a further object of the invention is to provide a work opportunity also for technicians who cannot invest in equipment such as casting systems and milling machines.

Another object of the invention is to provide a system that can be performed both for the upper arch and for the lower arch or for both simultaneously.

Another object is to provide a system adapted to manufacture a final or even temporary prosthesis, if at a later stage one decides to provide a prosthesis by means of other types of Toronto bridge, for example made of ceramic, composite material or acrylic material.

This aim and these and other objects which will become better apparent hereinafter are achieved by a structure for manufacturing dental prostheses, characterized in that it comprises a set of modular members constituted by a straight bar, a curved bar, a plurality of cylinders and distal bars, adapted to be assembled and soldered to each other to form a reinforcement frame of a dental prosthesis.

This aim and these and other objects that will become better apparent hereinafter are also achieved by a method for manufacturing dental prostheses, characterized in that it comprises assembling the components of a structure according to claim 1 and soldering said components to each other so as to form a rigid reinforcement frame of a dental prosthesis.

Further characteristics and advantages will become better apparent from the description of preferred but not exclusive embodiments of the invention, illustrated by way of non-limiting example in the accompanying drawings, wherein:

FIG. 1 is a perspective view of a curved bar;

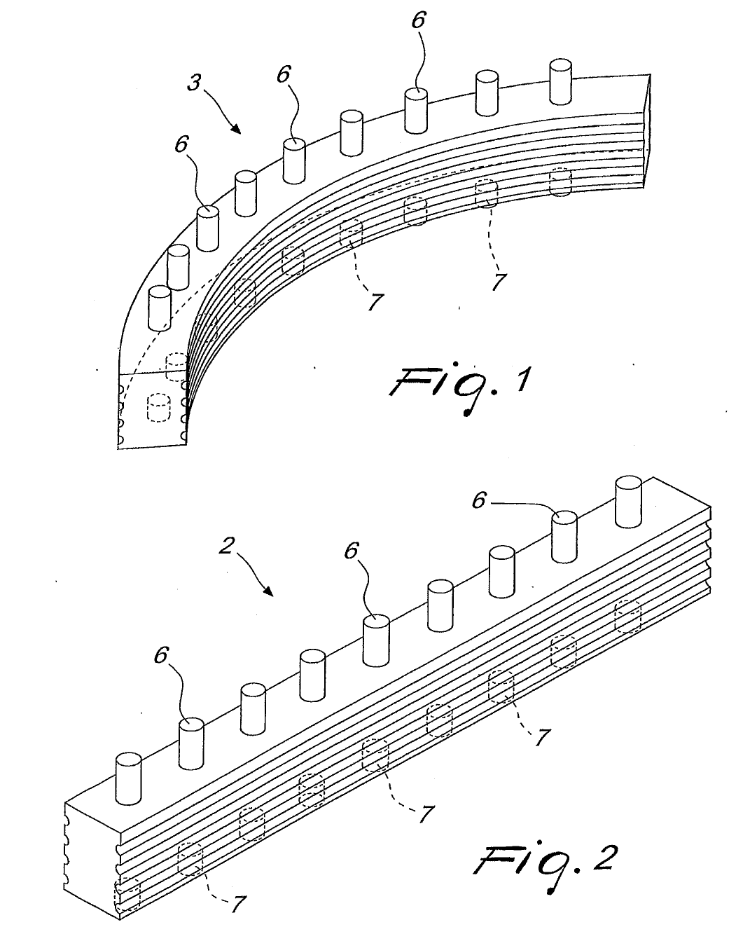

FIG. 2 is a perspective view of a straight bar;

FIG. 3 is a perspective view of an end member;

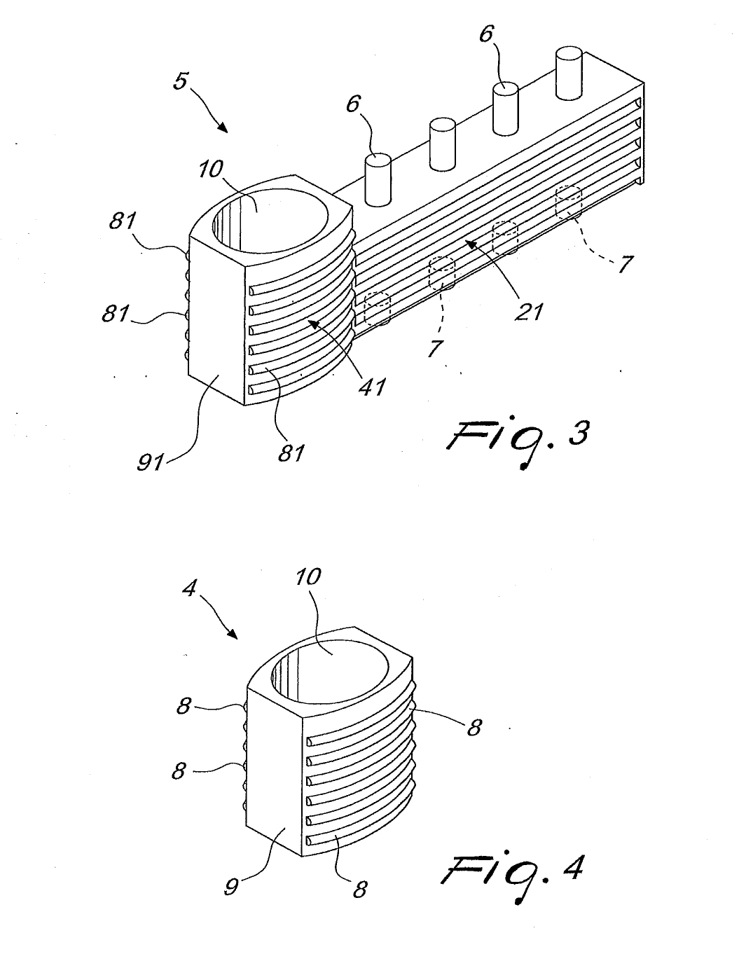

FIG. 4 is a perspective view of a cylinder;

FIG. 5 is a plan view of a curved bar;

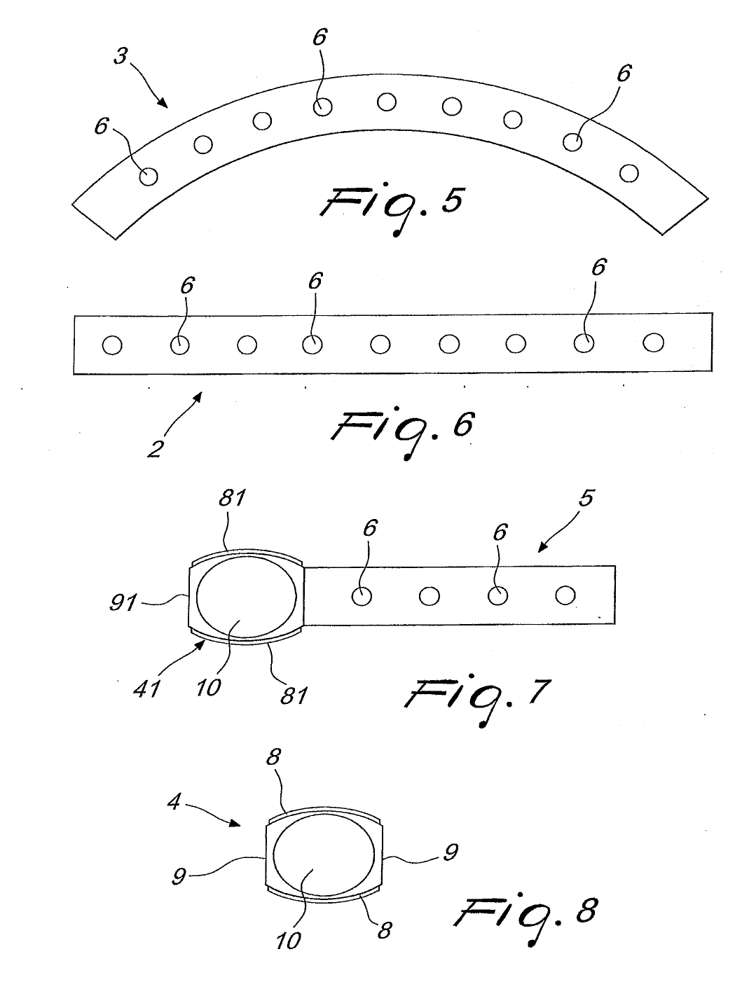

FIG. 6 is a plan view of a straight bar;

FIG. 7 is a plan view of an end member;

FIG. 8 is a plan view of a cylinder;

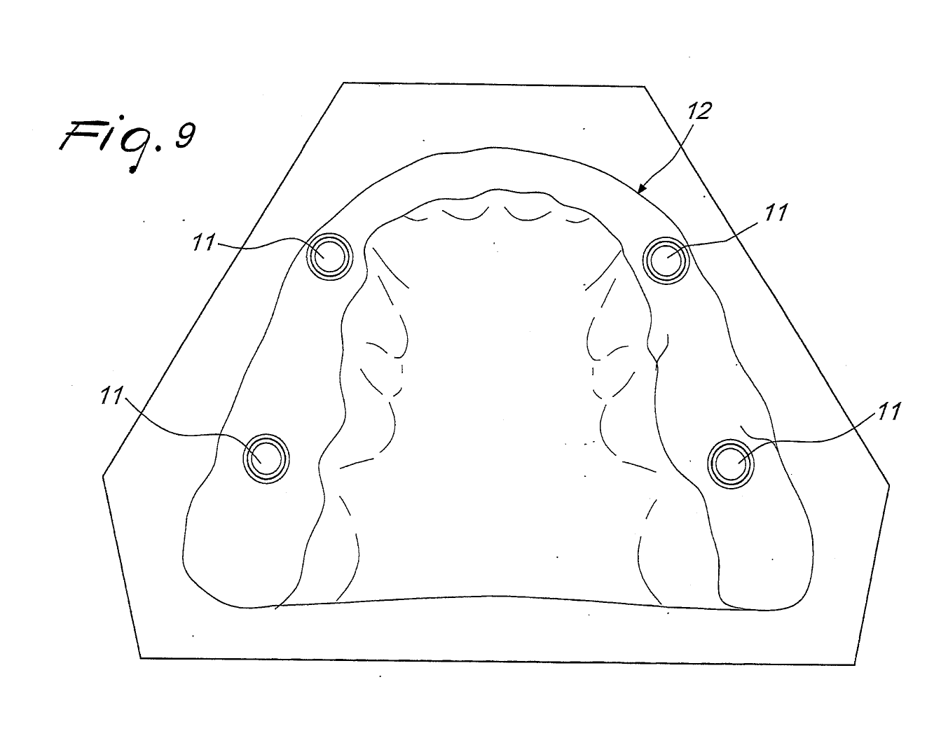

FIG. 9 is a plan view showing the plaster mold;

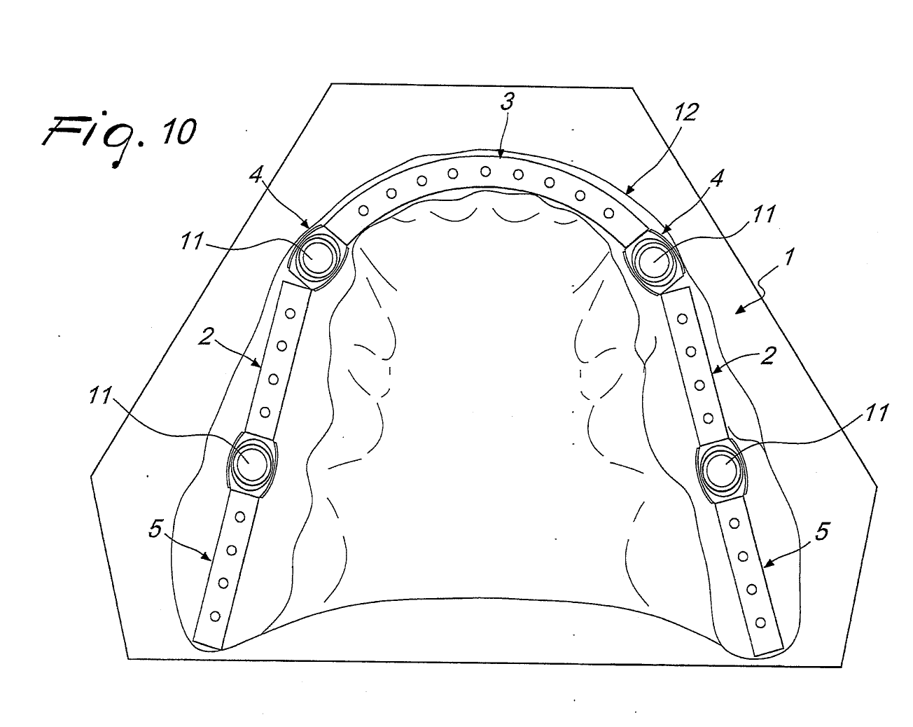

FIG. 10 is a plan view showing the assembled structure applied to the abutments;

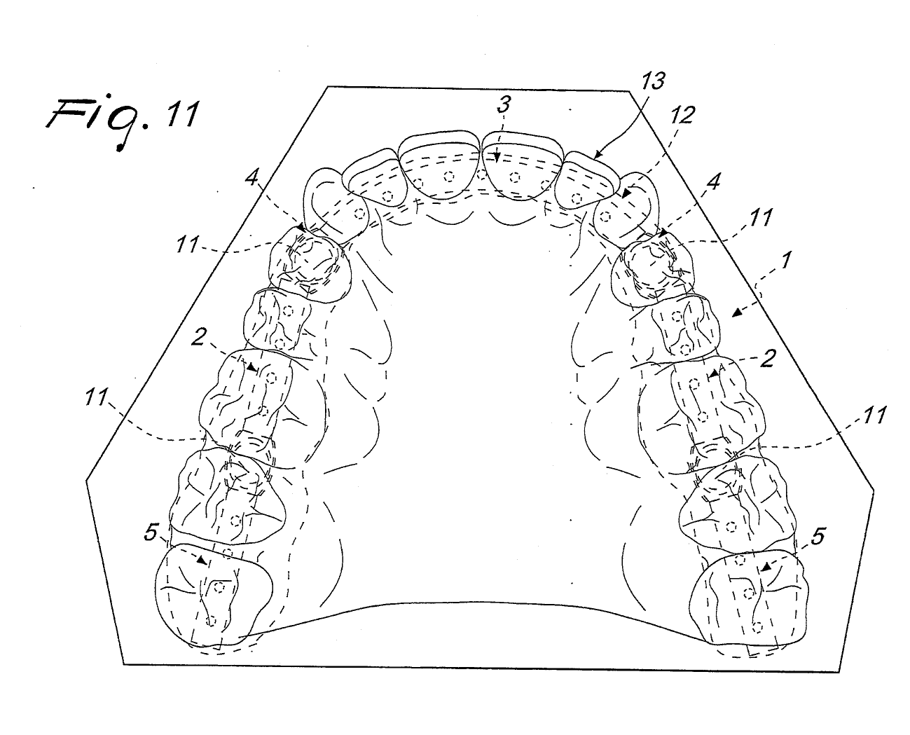

FIG. 11 is a plan view showing the completed prosthesis;

FIG. 12 is a perspective view of a curved bar, according to a further aspect of the invention;

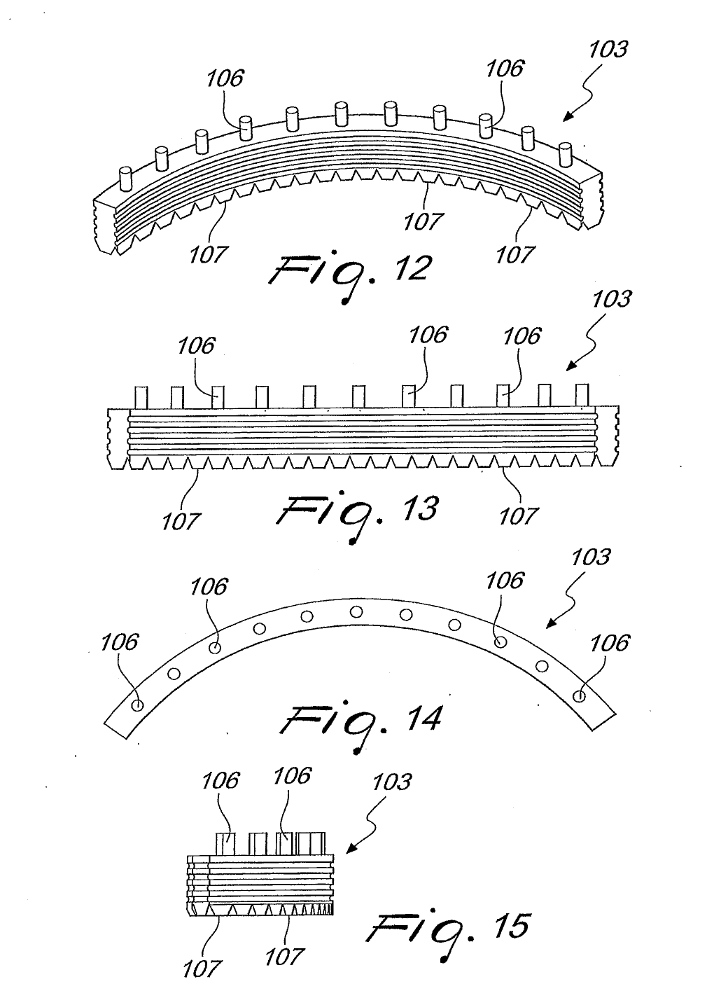

FIG. 13 is a front view of the curved bar of the preceding figure;

FIG. 14 is a plan view of the curved bar of the preceding figure;

FIG. 15 is a side view of the curved bar of the preceding figure;

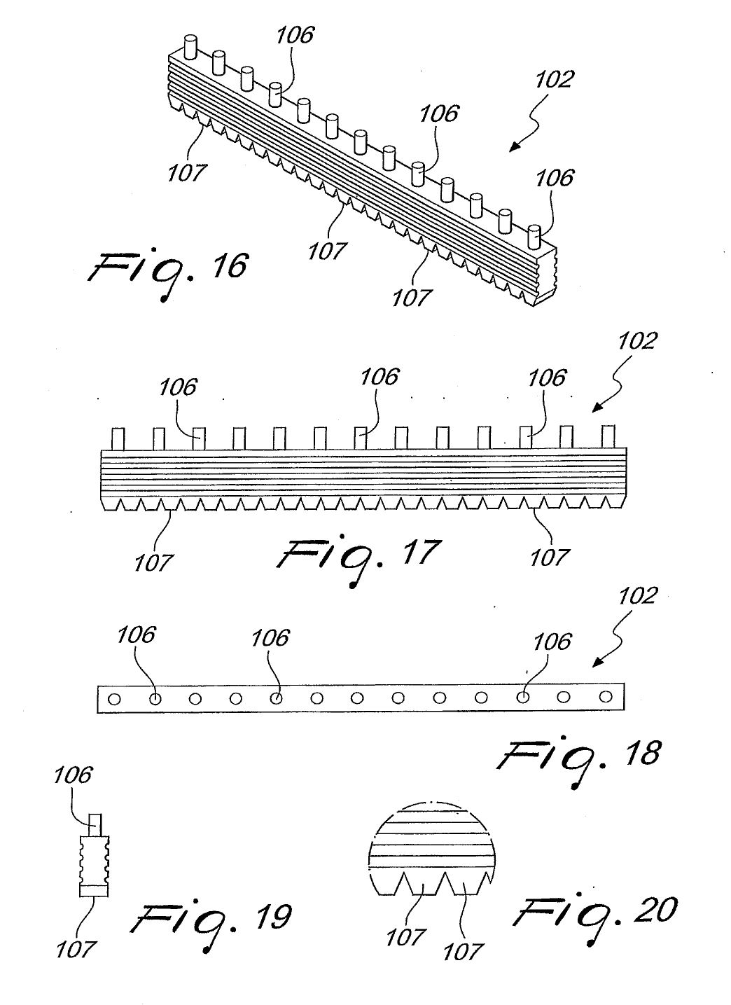

FIG. 16 is a perspective view of a straight bar according to a further aspect of the invention;

FIG. 17 is a front view of the straight bar of the preceding figure;

FIG. 18 is a plan view of the straight bar of the preceding figure;

FIG. 19 is a side view of the straight bar of the preceding figure;

FIG. 20 is an enlarged-scale view of a portion of the lower side of a bar;

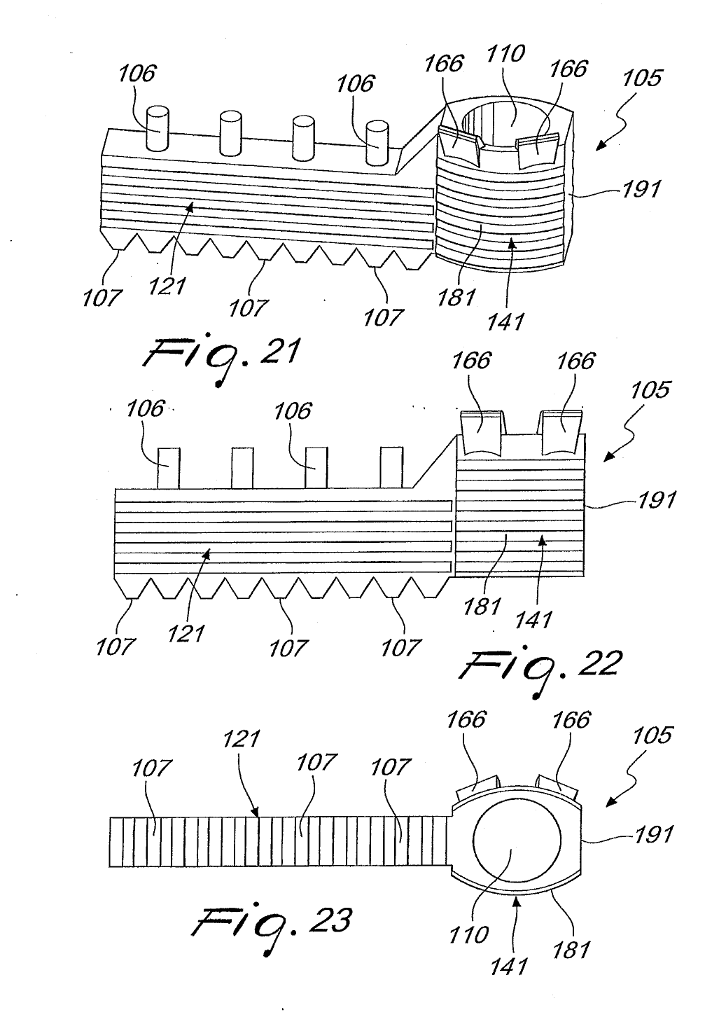

FIG. 21 is a perspective view of a right distal bar, according to a further aspect of the invention;

FIG. 22 is a front view of the right distal bar of the preceding figure;

FIG. 23 is a plan view of the right distal bar of the preceding figure;

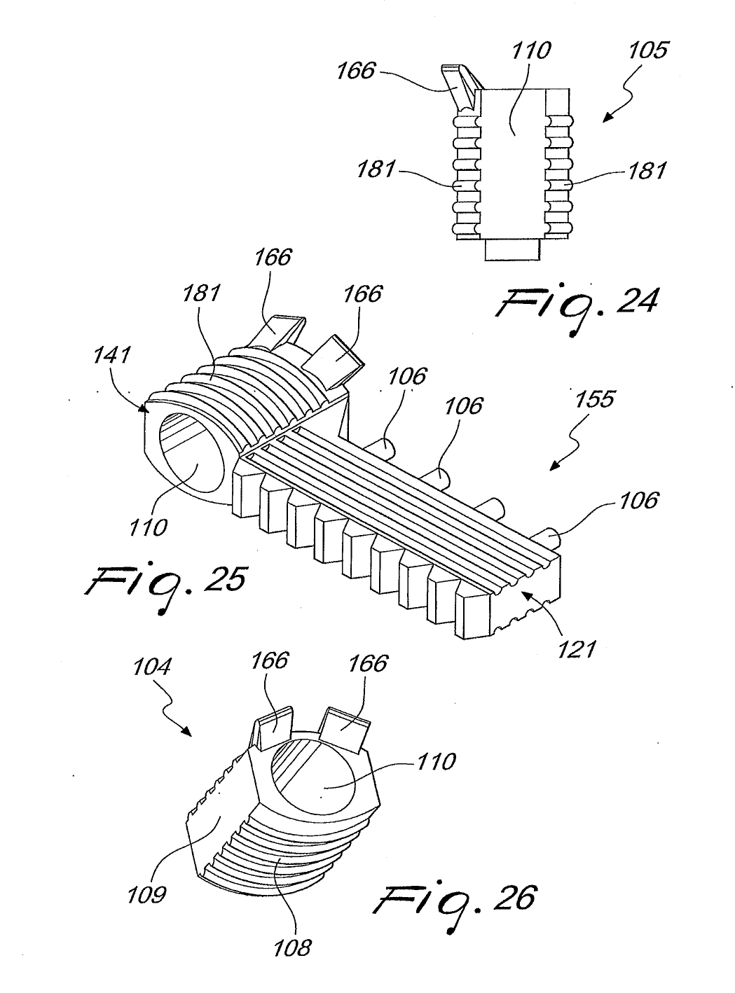

FIG. 24 is a side view of the right distal bar of the preceding figure;

FIG. 25 is a perspective view of a left distal bar, according to a further aspect of the invention;

FIG. 26 is a perspective view of a cylinder according to a further aspect of the invention.

With reference to the cited figures, the structure according to the invention comprises a set of modular members constituted by a straight bar 2, a curved bar 3, a plurality of cylinders 4 and two distal bars or end members 5.

The modular members have retention means configured to improve the embedding of the members in a resin or other material that constitutes the actual prosthesis and to provide fixing to temporary support members.

The straight bar 2 is constituted by an elongated member made of milled or laser melted chromium; the straight bar 2 has side grooves, a plurality of upper pins 6 and a plurality of lower pins 7, which constitutes the retention means.

The upper pins 6 improve the embedding of the bar in the resin or other material that constitutes the actual prosthesis, while the lower pins 7 are useful for fixing to members to a refractory material during the operation of mutual soldering of the modular members, as will be described hereinafter.

The curved bar 3 is manufactured in a manner similar to the straight bar and is constituted by a milled or laser melted chromium elongated member having side grooves and provided with a plurality of upper pins 6 and lower pins 7.

Each cylinder 4 is constituted by a tubular body, which has two outer sides 8, provided with grooves, and two substantially smooth sides 9 which can be soldered to the ends of bars 2 and/or 3.

The cylinder 4 is provided with a through hole 10, preferably having an ovoid or otherwise oblong cross-section, and adapted to receive an abutment 11, as will be described later.

Each end member 5 is constituted by an end cylinder 41, which is associated monolithically with one end of a bar portion 21.

The end cylinder 41 is constituted by a tubular body, which has two outer sides 81 provided with grooves and a substantially smooth side 91, which can be soldered to the ends of abutments of bars 2 and/or 3.

The bar portion 21 is constituted by an elongated member that is provided laterally with grooves and has a series of upper pins 6 and a series of lower pins 7.

FIGS. 12-26 show a structure, according to a further aspect of the invention, comprising a set of modular members constituted by a straight bar 102, a curved bar 103, a plurality of cylinders 104 and two distal bars, a right distal bar 105 and a left distal bar 155.

The straight bar 102 is constituted by an elongated member made of milled or laser melted chromium; the straight bar 102 has side grooves or ridges and has a plurality of upper pins 106 and a plurality of lower teeth 107.

The lower teeth 107 have a substantially trapezoidal cross-section and are extended transversely with respect of the longitudinal extension of the bar.

The upper pins 106 improve the embedding of the bar in the resin or other material that constitutes the actual prosthesis, while the lower teeth 107 are used for fixing to the refractory material while welding the modular members together, as will be described hereinafter.

The curved bar 103 is manufactured in a manner similar to the straight bar and is constituted by an elongated member made of milled or laser melted chromium having side grooves or ridges and a plurality of upper pins 106 and lower teeth 107.

Each cylinder 104 is constituted by a tubular body, which has two outer sides 108, provided with grooves or ridges and two substantially smooth sides 109. The smooth sides 108 are adapted to be welded to the ends of abutments of bars 102 and/or 103.

The cylinder 104 is provided with a through hole 110 and upper wings 106.

The upper wings 106 provided on the cylinder 104 have a function that is similar to the pins 106 of the bars and improve the embedding in the resin or other material that constitutes the actual prosthesis.

Each distal bar 105, 155 is constituted by an end cylinder 141 associated monolithically with one end of a bar portion 121.

The end cylinder 141 is constituted by a tubular body, which has two outer sides 181 provided with grooves and a substantially smooth side 191, which can be soldered to the ends of abutments of bars 102 and/or 103.

The end cylinder 141 is provided with a through hole 110 and with upper wings 106.

The upper wings 106 provided on the cylinder 104 have a function that is similar to the pins 106 of the bars and improve the embedding in the resin or other material that constitutes the actual prosthesis.

The bar portion 121 is constituted by an elongated member having side grooves or ridges and a plurality of upper pins 106 and lower teeth 107.

The method and the structure according to the present invention allow to manufacture one or two final prostheses a few hours after the insertion of the implants in the patient by the surgeon.

The components of the structure described above are preferably made of milled chromium or chromium with a laser melting technique.

According to the method of the present invention, the components are soldered to each other by means of a soldering alloy so as to provide a rigid structure, designated by the reference numeral 1.

The method for providing the prosthesis, according to the present invention, includes the insertion of the implants and the immediate taking of a plaster impression 12.

The plaster ensures maximum precision, but it is possible to use other methods that are known in the field.

Abutments 11 are screwed on the plaster impression 12 and cylinders 4, 41, 104 and 141 are fitted on each implant. The through hole 10, 110 of each cylinder allows a sufficiently loose play.

The operator proceeds with assembling the various components by cutting the bars 2 and/or 3 in order to adapt them to the distances between the cylinders 4, which are applied to the abutments 11.

The abutments 11 may be constituted by tubular members.

Then the components 2, 3, 4 and 5 are mutually soldered.

Once the structure 1 has been soldered, it is again applied to the abutments 11 with a certain play, by virtue of the presence of the holes 10, 110 in the cylinders 4, 41, 104 and 141.

The play between the abutment and the structure allows, by means of an adapted adhesive, to achieve optimum passivation.

This passivation method allows to eliminate all the frictions and tensions of the implants and therefore allows greater durability over time of said implants.

The screws that fix the structure must not be under tension in any way with respect to each other.

The components of the system are compatible and can be used with the majority of the most important implant manufacturers.

After passivating the structure, one proceeds with the aesthetic test, which allows to correct any defects in shape, color or orientation of the teeth.

If the test has a positive outcome, the prosthesis is finished by replacing the wax with a resin 13, and the entire system is polished.

Once the prosthesis has been delivered, the prosthesis technician installs the prosthesis in the mouth of the patient, adjusting both dynamic and static mastication by selective grinding.

In practice it has been found that the invention achieves the intended aim and objects, providing an extremely simple technique by means of which it is easy to form the metallic frame of the prosthesis by virtue of the modular structure constituted by prefabricated and preformed members.

The present invention facilitates the work of the surgeon who, during the initial steps of operation, can insert the implants in the most appropriate seat without worrying about structural requirements of the system.

Contrary to the prepackaged systems known so far, the patient, by means of an aesthetic test a few hours after the procedure, can appreciate his new smile and optionally, with the aid of professionals, make any modifications.

Since the prosthesis, with the teeth mounted thereon, is manufactured and tested on the spot, once finished it can be considered final for all purposes also due to the presence of the rear cantilevers, formed by the terminals 5.

With a system that is extremely simple and safe, the patient is discharged within the day, with the maximum possible assurance of effectiveness of the prosthesis and optimum passivity of the work, which leads to optimum durability of the implant.

In view of the fact that the protocol of immediate loading does not provide, or recommends strongly against, the use of cantilevers, i.e., cantilevered rear extensions, the system according to the present invention, which has rear cantilevers that are not loaded, i.e., lacking dental members, allows, a few months later, once integration and healing have occurred, to add rear dental members and restore mucous supports.

In case of any aesthetic and/or functional changes also, the present system provides for complete reworking of the coating part without compromising at all the structural solidity of the bar.

A few years later, if needed, in the presence of worn teeth, it is possible to restore completely the original aesthetics and function, performing a new assembly of the dental members without acting on the structure.

The system according to the present invention uses a dedicated kit, which by offering the preparation of a single prosthesis screwed onto implants allows a considerable cost reduction.

With respect to systems that provide for the use of multiple prostheses, the saving leads immediately to greater accessibility to broader slices of the population.

Moreover, the present invention offers considerable advantages to the patient. In addition to the considerable economic advantage, there is also an enormous advantage at the comfort level. The patient no longer has the prospect of the discomfort of wearing nonconforming total prostheses for a more or less long period of time; but with distinctly short times and in a single session the patient, entering the surgery in the morning even with natural teeth to be removed, leaves in the evening with fixed teeth that simulate perfectly what was the natural set of teeth, enabling him immediately to master social relations.

Contrary to the background art cited above, the present invention allows, by virtue of prefabricated modular members advantageously provided by laser sintering, to manufacture within a day a metal reinforcement that is extremely strong, joined by virtue of simple solders, and perfectly passive, since the implants are free from tensions. The present invention allows, within a few hours, to deliver a final prosthesis that is screwed onto the implants, is absolutely stable, is aesthetically and functionally valid and is economically sustainable.

This application claims the priority of Italian Patent Application No. MI2013A002191, filed on Dec. 23, 2013, the subject matter of which is incorporated herein by reference.

1. An assembly for manufacturing dental prostheses, comprising a set of modular members including at least one straight bar, at least one curved bar, a plurality of cylinders and distal bars, adapted to be assembled and soldered to each other to form a reinforcement frame of a dental prosthesis.

2. The assembly according to claim 1, wherein said straight bar is an elongated member having side grooves and a plurality of upper pins and lower pins; said upper pins being adapted to improve the embedding of said bar in a material that constitutes said prosthesis; said lower pins being adapted to temporarily fasten said modular members to a refractory material while soldering said modular members to each other.

3. The assembly according to claim 1, wherein said curved bar is an elongated member having side grooves and a plurality of upper pins and lower pins; said upper pins being adapted to improve the embedding of said bar in a material that constitutes said prosthesis; said lower pins being adapted to temporarily fasten said modular members to a refractory material while soldering said modular members to each other.

4. The assembly according to claim 1, wherein each cylinder is a tubular body, which has two outer sides provided with grooves and two substantially smooth sides, which can be soldered to ends of said bars.

5. The assembly according to claim 4, wherein each cylinder has a through hole.

6. The assembly according to claim 1, wherein said modular members comprise end members, each end member being an end cylinder that is associated monolithically with one end of a bar portion; said end cylinder being a tubular body which has two outer sides provided with grooves and a substantially smooth side, which can be soldered to the ends said bars; said bar portion being constituted by an elongated member having side grooves and a plurality of upper pins and lower teeth.

7. The assembly according to claim 1, wherein each of said modular members comprises a retention component configured to improve the embedding of said modular members in a material that constitutes a prosthesis and to provide fixing for temporary support members.

8. The assembly according to claim 7, wherein said retention component comprises a series of plurality upper pins and lower teeth formed on said bars.

9. The assembly according to claim 8, wherein said lower teeth have a substantially trapezoidal cross-section and are extended transversely with respect to a longitudinal extension of the bar.

10. The assembly according to claim 1, wherein said retention component comprises wings formed on said cylinders.

11. A method for manufacturing dental prostheses, comprising assembling the components of a structure according to claim 1 and soldering said components to each other so as to form a rigid reinforcement frame of a dental prosthesis.

12. A method for manufacturing dental prostheses according to claim 11, further comprising:
mounting abutments at implants that are present on a model of a dental arch;
applying a cylinder to each abutment and assembling said components on said model,
cutting said bars to adapt them to the distances between said cylinders applied to said abutments;
soldering said components to each other, providing a rigid structure;
applying said structure to said abutments by means of an adhesive, leaving play between said cylinders and said abutments;
applying wax, forming a temporary prosthesis structure;
performing an aesthetic test to correct any defects in shape, color or orientation of the teeth;
finishing the prosthesis, replacing the wax with a resin.
